(19) United States
(12) Patent Application Publication
(10) Pub. No.: US 2002/0134490 A1
(43) Pub. Date: Sep. 26, 2002

(54) Method of making tire rubber component

(76) Inventor: Kazuya Suzuki, Kobe-shi (JP)

Correspondence Address: BIRCH STEWART KOLASCH & BIRCH, PO BOX 747, FALLS CHURCH, VA, 22040-0747, US

(21) Appl. No.: 10/020,161

(22) Filed: Dec. 18, 2001

(30) Foreign Application Priority Data
Dec. 21, 2000 (JP) 2000-389281

(51) Int. Cl. B29D 30/00

(52) U.S. Cl. 156/123; 156/130.5

(57) ABSTRACT

A method of making an annular rubber component of a tire comprises: determining a cross sectional shape of an annular rubber component; allotting thicknesses and widths to unvulcanized rubber strips, based on the cross sectional shape of the annular rubber component which is formed by piling up the unvulcanized rubber strips, the thicknesses being in a range of from 0.5 to 4.0 mm; determining relative displacement of circumferential ends of the unvulcanized rubber strips; and winding the unvulcanized rubber strips on a cylindrical surface so that the ends of each unvulcanized rubber strip are jointed, and the joints of the unvulcanized rubber strips are shifted from each other in the circumferential direction.

The present invention relates to a method of making an annular rubber component of a tire such as tread rubber, sidewall rubber, bead apex rubber and the like.

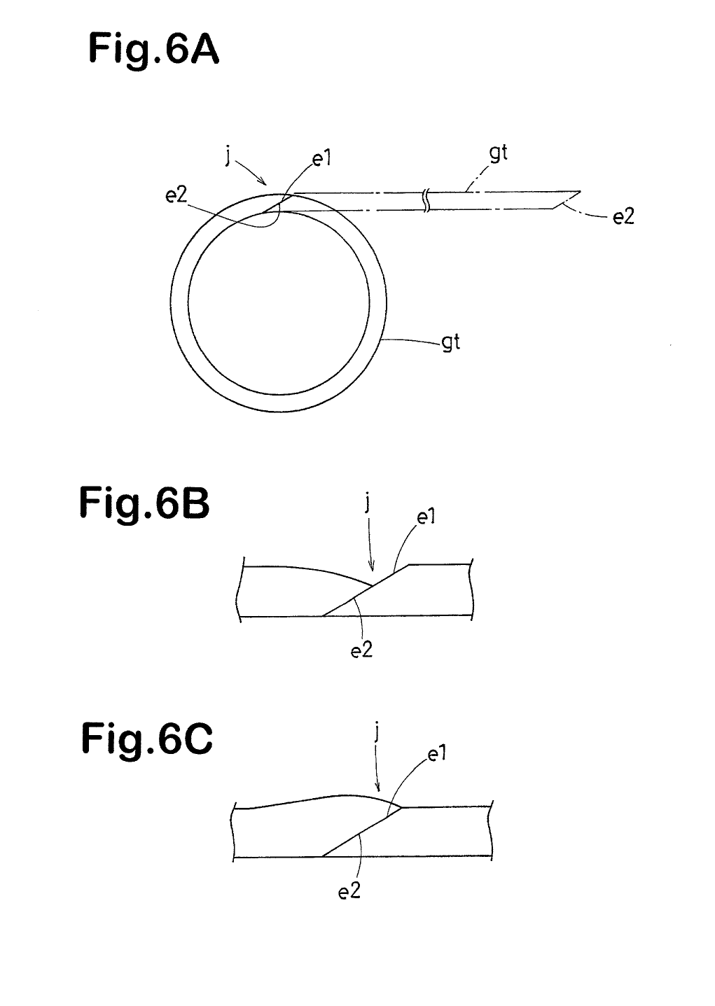

In general, a pneumatic tire has a tread portion forme d by winding a strip (gt) of a tread rubber compound around a tire building drum as shown in FIG. 6A. The tread rubber strip (gt) is extruded from a tread extruder and cut into a predetermined length by a tread skiver. The ends (e1 and e2) are butt-jointed in one position—one joint j is formed.

As the tread rubber strip (gt) is not yet vulcanized, it is easily elongated or compressed in the longitudinal direction. Thus, if the strip length is shorter than the winding length, a joint dent is liable to occur as shown in FIG. 6B. If the strip length is longer than the winding length, a joint bulge is liable to occur as shown in FIG. 6C. In either case, not only the tire uniformity especially RFV becomes worse, also the strength tends to decrease at the joint (j). If the strength is not enough, so called open tread joint (OTJ), such a phenomenon that the joint is broken is liable to occur when the wear of the tread rubber progresses.

The sidewall rubber in the tire sidewall portions also involve the same problems, namely, joint dent and joint bulge.

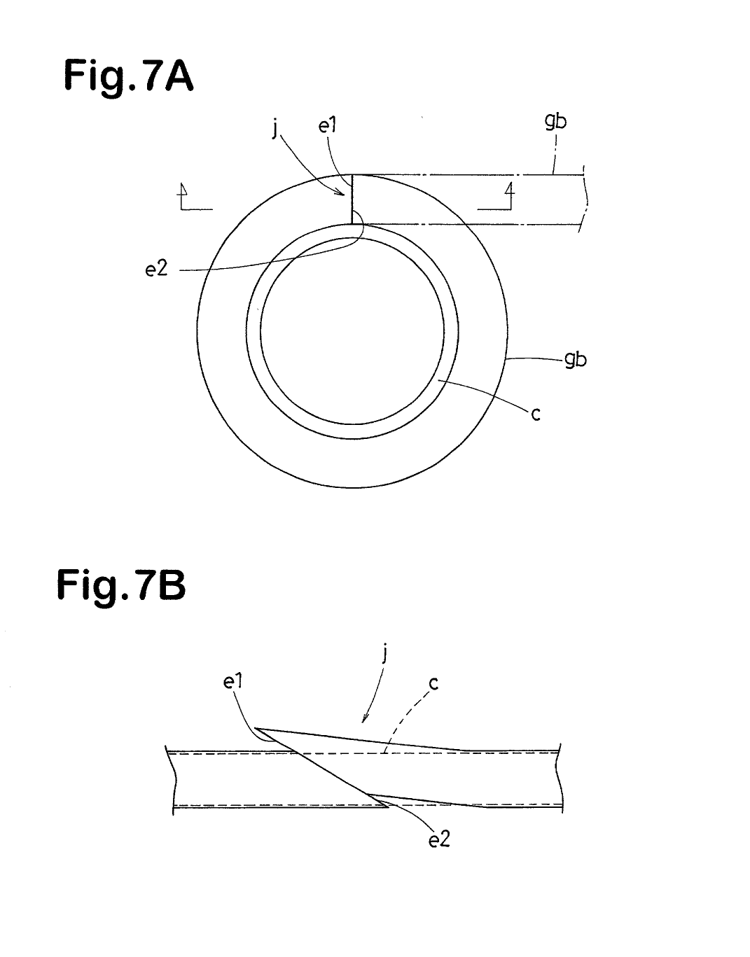

In case of a bead apex, as shown in FIGS. 7A and 7B, an extruded strip (gb) of a bead apex rubber compound is applied in advance onto the radially outside of a annular bead core (c). And the cut ends e1 and e2 are butt-jointed in one position (j).

As the bead apex rubber strip (gb) tapers radially outwards, the size is not so small in the radial direction, but in the tire axial direction, it becomes very small towards the radially outer end thereof. Therefore, as shown in FIG. 7B, even if a slippage between the ends e1 and e2 is absolutely small, it is not relatively small. As a result, adhesive failure is liable to occur.

It is therefore, an object of the present invention to provide a method of making an annular tire rubber component, by which a dent, bulge, slippage and resultant strength decrease, uniformity deterioration and the like in the joint can be prevented.

According to one aspect of the present invention, a method of making an annular rubber component of a tire comprises

determining a cross sectional shape of an annular rubber component,

allotting thicknesses and widths to unvulcanized rubber strips, based on the cross sectional shape of the annular rubber component which is formed by piling up the unvulcanized rubber strips, wherein the thicknesses is in a range of from 0.5 to 4.0 mm,

determining relative displacement of circumferential ends of the unvulcanized rubber strips, and

winding the unvulcanized rubber strips on a cylindrical surface so that the ends of each of the unvulcanized rubber strips are jointed, and the joints of the unvulcanized rubber strips are shifted from each other in the circumferential direction.

Embodiments of the present invention will now be described in detail in conjunction with the accompanying drawings.

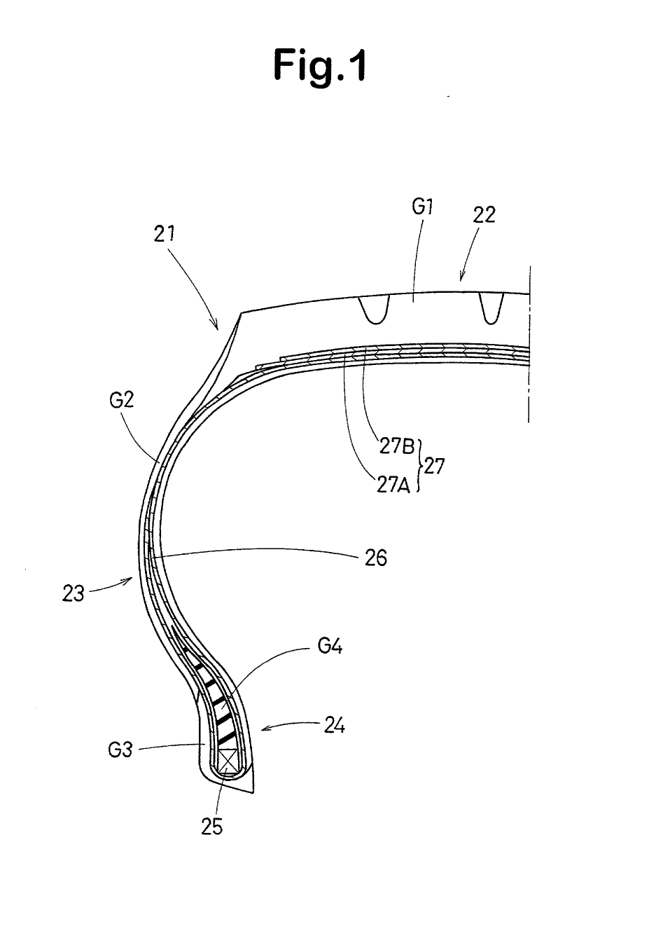

FIG. 1 is a cross sectional view of a pneumatic tire according to the present invention.

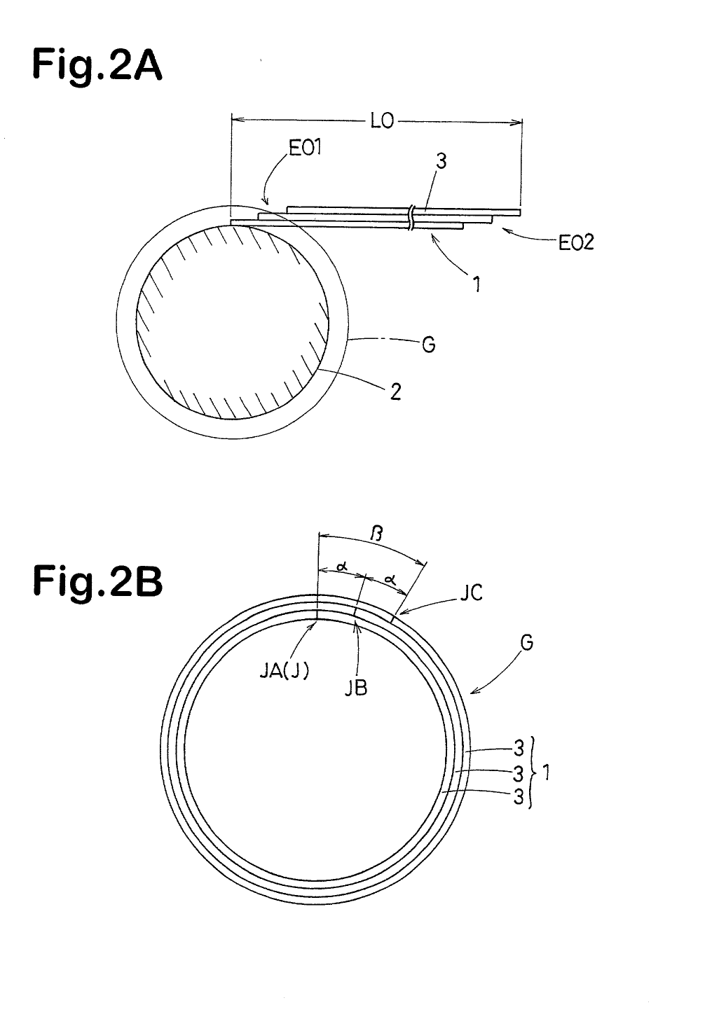

FIGS. 2A and 2B are diagrams for explaining a method of making a tire rubber component.

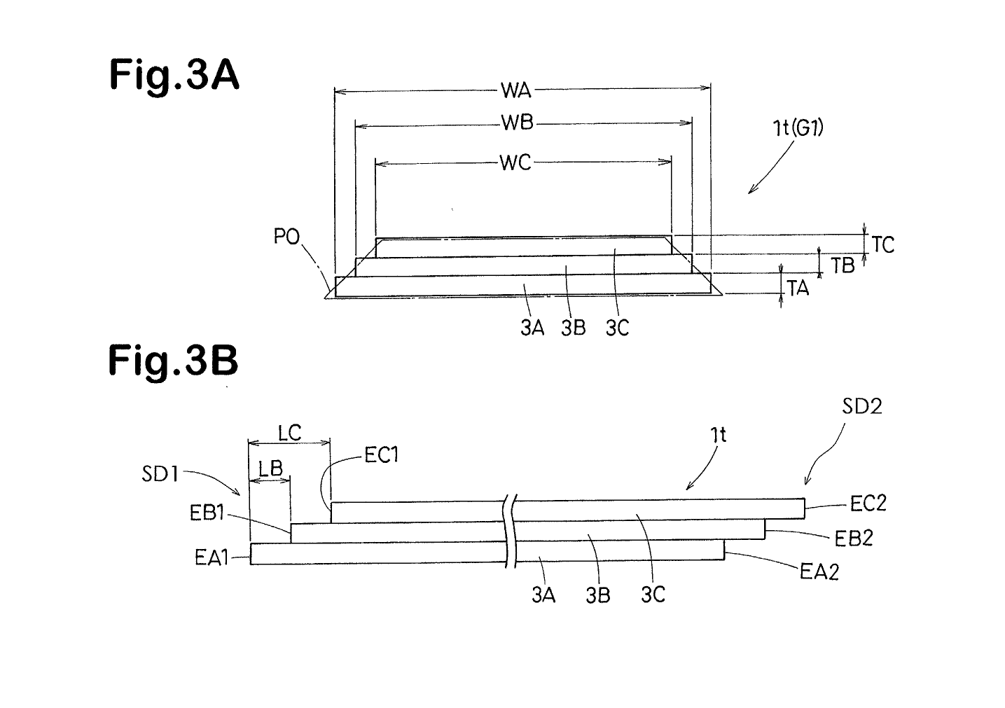

FIG. 3A is a cross sectional view of an tread rubber strip taken along the widthwise direction thereof.

FIG. 3B is a cross sectional view thereof taken along the longitudinal direction thereof.

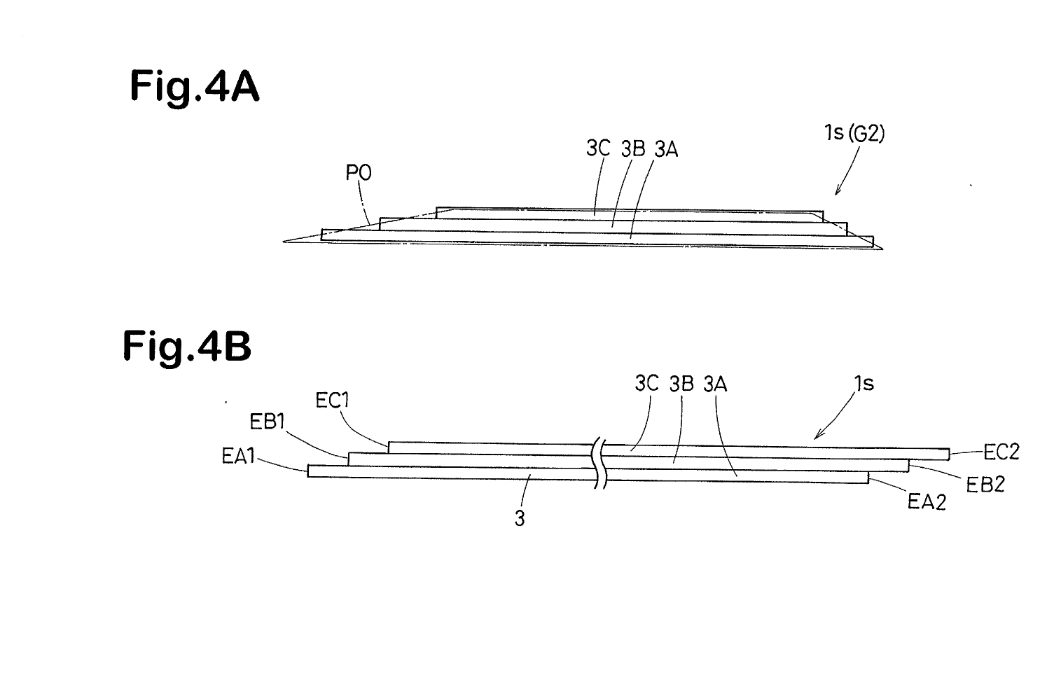

FIG. 4A is a cross sectional view of a sidewall rubber strip taken along the widthwise direction thereof.

FIG. 4B is a cross sectional view thereof taken along the longitudinal direction thereof.

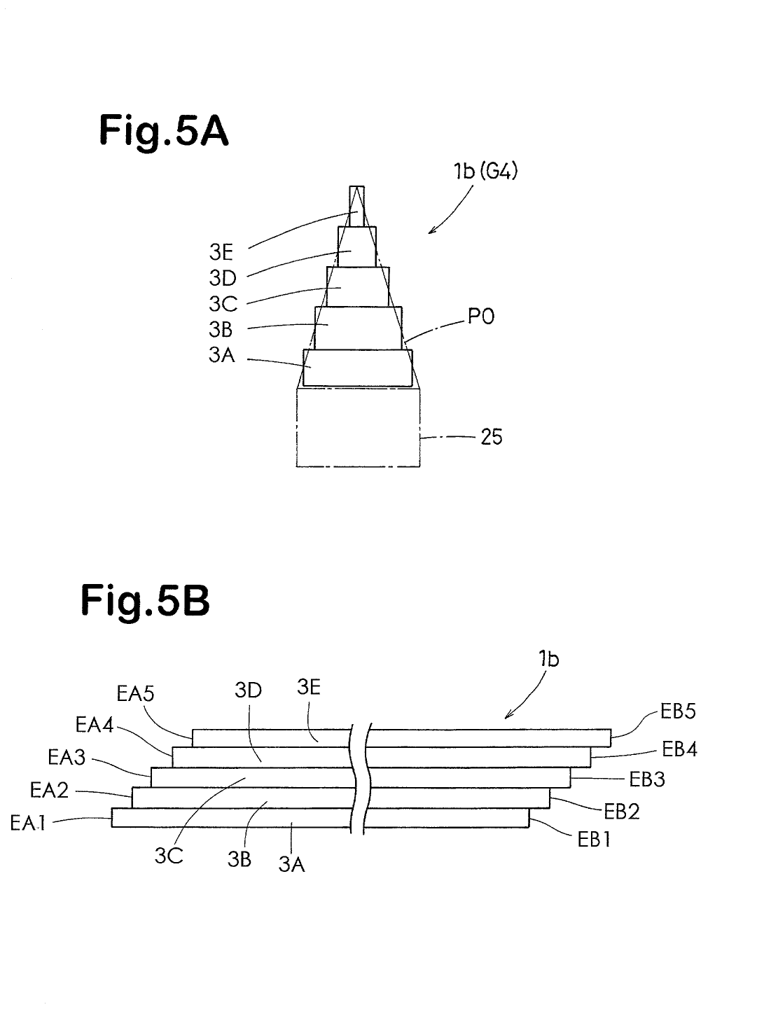

FIG. 5A is a cross sectional view of a bead apex rubber strip taken along the widthwise direction thereof.

FIG. 5B is a cross sectional view thereof taken a long the longitudinal direction thereof.

FIG. 6A is a diagram showing the conventional tread rubber strip.

FIGS. 6B and 6C are diagrams showing a joint dent and a joint bulge by the conventional tread rubber strip, respectively.

FIG. 7A is a diagram showin g the conventional bead apex rubber strip.

FIG. 7B is a diagram showing a joint slippage in the conventional bead apex rubber strip.

In FIG. 1, a pneumatic tire 21 according to the present invention comprises a tread portion 22, a pair of sidewall portions 23, a pair of axially spaced bead portions 24 each with a bead core 25 therein, a carcass 26 extending between the bead portions 24, and a belt 27 disposed radially outside the carcass 26 in the tread portion 22.

The carcass 26 comprises at least one p ly of cords extending between the bead portions 24 through the tread portion 22 and sidewall portions 23, and turned up around the bead core 25 in each bead portion 24 to be secured thereto.

The belt 27 includes two cross breaker plies 27A and 27B and optionally a band ply (not provided in this example).

In the tread portion 22, a tread rubber G1 is disposed radially outside the belt 27. In the sidewall portion 23, a sidewall rubber G2 is disposed axially outside the carcass 26. In the bead portion 24, a bead rubber or clinch rubber G3 is disposed along the axially outer face and bottom face of the bead portion. Between a carcass ply turnup and carcass ply main, a bead apex rubber G4 is disposed. On the inside of the carcass, a gas-impermeable inner liner rubber is disposed covering the inside of the tire. If a gas-impermeable rubber compound is used as the carcass topping rubber, the inner liner rubber may be omitted.

Such pneumatic tire 21 may be formed as follows:

winding a thin inner liner rubber sheet on a cylindrical surface of a tire building drum to make the inner liner rubber;

winding a bead rubber strip to make the bead rubber G3 on each side of the inner liner rubber;

winding a sidewall rubber strip to make the sidewall rubber G2 on the axially outside of each bead rubber G3;

winding a rubberized unwoven cord fabric to make the carcass 26 on these rubbers around the cylindrical tire building drum;

placing the bead cores 25 with the bead apex rubber G4 wound therealong on the carcass 26;

changing the assembly of the above-mentioned wound components from the cylindrical shape to a toroidal shape while folding around the bead cores 25;

making a tread assembly of the belt and the tread rubber by winding strips of rubberized belt cords on another drum and winding a tread rubber strip thereon;

putting the annular tread assembly on the crown portion of the toroidal carcass; and

vulcanizing the green tire in a mold.

This method is typical but only an example. Other methods are also possible.

As explained above, a tire rubber component G such as the tread rubber G1, sidewall rubber G2, bead apex rubber G4 and the like is formed by winding an unvulcanized rubber strip directly or indirectly on a drum.

According to the present inventio n, as the above-mentioned unvulcanized rubber strip to be wound, a layered structure 1 of a plurality of thin unvulcanized rubber strips 3 is used. Thus, as shown in FIG. 2A and FIG. 2B, a tire rubber component G is formed by winding a layered structure 1 around a drum 2. Then, the circumferential ends E01 and E02 thereof are butt jointed.

FIG. 3A and FIG. 3B show a layered structure it wound into the tread rubber G1. The layered structure it is made up of three layers of unvulcanized rubber strips 3A, 3B and 3C disposed in this order from the radially inside to outside. The widths WA, WB and WC of the unvulcanized rubber strips 3A, 3B and 3C are gradually decreased from the radially inside to the outside (WA>WB>WC) in order to make the cross sectional shape of the layered structure it close to a trapezoid P0. According to the cross sectional shape required for the tread rubber, the widths WA, WB and WC can be set in another arrangement, for example, WA=WB=WC.

The unvulcanized rubber strips 3A, 3B and 3C have circumferential ends EA1, EB1 and EC1 on one side SD1 and circumferential ends EA2, EB2 and EC2 on the other side SD2, respectively. As shown in FIG. 3B, the ends EA1, EB1 and EC1 on the side SD1 are gradually shifted towards the side SD2, and the ends EA2, EB2 and EC2 on the side SD2 are gradually shifted towards the side SD1 in the reversed manner. If considered on the side SD1, the end EB1, EC1 of a radially outer strip 3B, 3C is shifted towards the side SD2 from the end EA1, EB1 of the radially inwardly adjacent strip 3A, 3B. If considered on the side SD2, on the other hand, the end EB2, EA2 of a radially inner strip 3B, 3A is shifted towards the side SD1 from the end EC2, EB2 of the radially outwardly adjacent strip 3C, 3B. The layered structure It is made one turn, and then the ends EA1, EB1 and EC1 and the ends EA2, EB2 and EC2 are butt-jointed, respectively. Accordingly, the joints JA, JB and JC thereof are shifted from each other as shown in FIG. 2B.

Thus, the circumferential ends E01 and E02 of the layered structure It are butt-jointed. In case of another layered structure (1s, 1b), butt-jointing is made in the same way as above.

FIG. 4A and FIG. 4B show a layered structure 1s wound into the sidewall rubber G2. The layered structure 1s in this example is made up of three unvulcanized rubber strips 3A, 3B and 3C disposed in this order from the radially inside to outside on the tire building drum. But, in the finished tire, the strip 3C is axially outermost. The widths WA, WB and WC of the unvulcanized rubber strips 3A, 3B and 3C are gradually decreased such that WA>WB>WC in order to make the cross sectional shape of the layered structure is close to a trapezoid P0.

FIG. 5A and FIG. 5B show a layered structure 1b wound into the bead apex rubber G4. The layered structure 1b is made up of five unvulcanized rubber strips 3A, 3B, 3C, 3D and 3E disposed in this order from the radially inside to outside. The widths of the unvulcanized rubber strips 3A-3E are gradually decreased from the radially inside to the outside in order to make the cross sectional shape of the layered structure 1b close to a triangle P0.

As a matter of course, each of the unvulcanized rubber strips 3 is thinner than the layered structure 1 as whole. Therefore, variation of the thickness and strength in each of the joints J (JA, JB, ---) is greatly decreased. Further, as the positions of the joints J are shifted, the variation is dispersed in the circumferential direction. As a result, the tire uniformity can be greatly improved.

To maximize this effect of the reduced thickness, the thickness T of each strip 3 is set in a range of not more than 4.0 mm. But, the thickness T should be more than 0.5 mm for the handling, production efficiency, accuracy and the like.

In case of tread rubber Gt or sidewall rubber Gs, the strip thickness T is preferably set in a range of from 0.5 to 2.0 mm in order to minimize a possible influence on the surface of the tire and tire performance.

It is preferable that, as shown in FIG. 2B, t he angularly shift (beta) around the tire axis between the joint JA of the radially innermost strip 3A and the joint JC of the radially outermost strip 3C is not more than 180 degrees, preferably not more than 90 degrees, and the angularly shift (alpha) between the joints J of the adjacent strips 3 is not less than 5 degrees, preferably more than 15 degrees.

If the angularly shift (alpha) is less than 5 degrees, the above-mentioned dispersion of the variations becomes insufficient. If the angularly shift (beta) is more than 180 degrees, the production efficiency and accuracy are liable to decrease.

In order to improve running performance, durability, weatherproof and the like, a plurality of unvulcanized rubber strips 3 of a layered structure 1 may include two or more kinds of strips which are different from each other with respect to rubber compound.

In case of the tread rubber Gt, for example, it is possible to make the innermost strip 3A from a hardest rubber compound to improve the tread rigidity. Also, it may be possible to make the innermost strip 3A from a low hysteresis loss rubber compound to improve fuel consumption performance, heat generation and the like.

In case of the sidewall rubber Gs, it is possible to make the axially outermost strip from a hardest rubber compound to improve the cut resistance, or a weatherproof rubber compound.

Comparison Test 1

Pneumatic tires of size 195/65R15 were made, wherein the tread rubbers were formed by the layered structures shown in Table 1. The tires were tested as follows.

1) Radial force variation (RFV) test: The radial force variation was measured with a force variation tester according to the Japanese standard JASO-C607. In Table 1, the average value for fifty sample tiers is shown.

2) Open tread joint (OTJ) test: Using an abrasion tester, the tread portion was worn to the wear indicator. Then, the tire was checked for crack and separation at the strip joints.

TABLE 1

| Tire | Ref. | Ex. 1 | Ex. 2 | Ex. 3 | Ex. 4 |
|---|---|---|---|---|---|
| Material rubber | | | | | |
| Thickness (mm) | 6 | 6 | 6 | 6 | 6 |
| No. of strips | — | 3 | 3 | 3 | 3 |
| Sheet thickness T (mm) | — | 2.0/2.0/2.0 | 2.0/2.0/2.0 | 2.0/2.0/2.0 | 2.0/2.0/2.0 |
| in/out | | | | | |
| Sheet width W (mm) | — | 210/200/190 | 210/200/190 | 210/200/190 | 210/200/190 |
| in/out | | | | | |
| Angularly shift alpha (deg.) | — | 90 | 45 | 15 | 10 |
| Angularly shift beta (deg.) | — | 180 | 90 | 30 | 20 |
| RFV (kgf/sq · cm ) | 6.3 | 5.2 | 5.4 | 5.9 | 6.2 |
| OTJ (%) | 6 | 0 | 0 | 0 | 0 |

Inner pressure 200 kpa, Tire load 450 kgf

Comparison Test 2

Pneumatic tires of size 195/65R15 were made, wherein the sidewall rubbers were formed by the layered structures shown in Table 2. The tires were checked for joint dent and bulge in the sidewall portions by visual observation and ranked into five ranks, wherein the higher rank number is better.

TABLE 2

| Tire | Ref. | Ex. 1 | Ex. 2 | Ex. 3 | Ex. 4 |
|---|---|---|---|---|---|
| Material rubber | | | | | |
| Thickness (mm) | 6 | 6 | 6 | 6 | 6 |
| No. of strips | — | 3 | 3 | 3 | 3 |
| Sheet thickness T (mm) | — | 2.0/2.0/2.0 | 2.0/2.0/2.0 | 2.0/2.0/2.0 | 2.0/2.0/2.0 |
| in/out | | | | | |
| Sheet width W (mm) | — | 120/110/100 | 120/110/100 | 120/110/100 | 120/110/100 |
| in/ou | | | | | |
| Angularly shift alpha (deg.) | — | 90 | 45 | 15 | 10 |
| Angularly shift beta (deg.) | — | 180 | 90 | 30 | 20 |
| Bulge/dent | 3 | 5 | 5 | 5 | 4 |

Comparison Test 3

A thousand pieces of bead apex rubber were made using each of the layered structures shown in Table 3 to obtain the per cent defectives. If the ends in a joint shifted in the widthwise direction more than 3.0 mm and/or a gap was formed between the ends in a joint, then it was judge defective.

TABLE 3

| Bead apex rubber | Ref. | Ex. 1 | Ex. 2 | Ex. 3 | Ex. 4 | Ex. 5 |
|---|---|---|---|---|---|---|
| Material rubber | | | | | | |
| Thickness (mm) | 20 | 20 | 20 | 20 | 20 | 20 |
| No. of strips | — | 5 | 5 | 5 | 5 | 5 |
| Sheet thickness T (mm) | — | 4/4/4/4/4 | 4/4/4/4/4 | 4/4/4/4/4 | 4/4/4/4/4 | 4/4/4/4/4 |
| in/out | | | | | | |
| Sheet width W (mm) | — | 5/5.5/4/2.5/1 | 5/5.5/4/2.5/1 | 5/5.5/4/2.5/1 | 5/5.5/4/2.5/1 | 5/5.5/4/2.5/1 |
| in/out | | | | | | |
| Angularly shift alpha (deg.) | — | 90 | 45 | 20 | 10 | 5 |
| Angularly shift beta (deg.) | — | 360 | 180 | 80 | 40 | 20 |
| Defective (%) | 3 | 0 | 0 | 0 | 0 | 0 |

As described above, in the present invention, as the unvulcanized rubber strips are thin and the joints are shifted in the circumferential direction, the rubber component is greatly improved in the variations of the thickness and strength, and thus the tire uniformity, tire durability and the like can be greatly improved.

1. A method of making an annular rubber component of a tire comprising
determining a cross sectional shape of an annular rubber component,
allotting thicknesses and widths to unvulcanized rubber strips, based on said cross sectional shape of the annular rubber component which is formed by piling up said unvulcanized rubber strips, said thicknesses being in a range of from 0.5 to 4.0 mm,
determining relative displacement of circumferential ends of said unvulcanized rubber strips, and
winding said unvulcanized rubber strips on a cylindrical surface so that the ends of each said unvulcanized rubber strip are jointed, and the joints of said unvulcanized rubber strips are shifted from each other in the circumferential direction.

2. A method of making a tire rubber component according to claim 1, wherein
an angularly shift between the joint s of the adjacent unvulcanized rubber strips is in a range of not less than 5 degrees.
the angularly shift between the joint of the radially innermost unvulcanized rubber strip and the joint of the radially outermost unvulcanized rubber strip is not more than 180 degrees.

3. A method of making a tire rubber component according to claim 1 or 2, wherein
said unvulcanized rubber strips include two or more unvulcanized rubber strips which are different from each other with respect to rubber composition.

4. A method of making a tire rubber component according to claim 1, 2 or 3, wherein
the tire rubber component is a tread rubber or a sidewall rubber, and
the thicknesses of the unvulcanized rubber strips are in a range of from 0.5 to 2.0 mm.

5. A method of making a tire rubber component according to claim 1, 2 or 3, wherein
the tire rubber component is a bead apex rubber, and
the thicknesses of the unvulcanized rubber strips are in a range of from 0.5 to 4.0.

6. A method of making a pneumatic tire co mprising rubber components, which, in order to make at least one of said rubber components, includes the method according to claim 1.

7. A pneumatic tire comprising rubber components at least one of which is made by the method according to claim 1.
